(19) United States
(12) Patent Application Publication
(10) Pub. No.: US 2002/0026639 A1
(43) Pub. Date: Feb. 28, 2002

(54) Information processing system, information processing method, and recording medium

(76) Inventor: Naoya Haneda, Tokyo (JP)

Correspondence Address: SONNENSCHEIN NATH & ROSENTHAL, P.O. BOX 061080, WACKER DRIVE STATION, CHICAGO, IL, 60606-1080, US

(21) Appl. No.: 09/934,321

(22) Filed: Aug. 21, 2001

(30) Foreign Application Priority Data
Aug. 22, 2000 (JP) P2000-250531

(51) Int. Cl. H04N 7/173; H04N 7/16

(52) U.S. Cl. 725/87; 725/92; 725/1; 725/96; 725/134

(57) ABSTRACT

A requesting unit receives application information which is transmitted by an information terminal device, and transmits a content ID to an information storing device based on the application information. A converting unit converts the content received by the information storing device into data in a predetermined format and with a predetermined data rate based on a format ID included in the application information which is received by the information storing device, and distributes the data to the information terminal device via a communication unit.

### BACKGROUND OF THE INVENTION

1. Field of the Invention

The present invention relates to an information processing system, an information processing method, and a recording medium. More particularly, the present invention relates to an information processing system, an information processing method, and a recording medium which convert various digital contents including multimedia data such as a moving picture and audio data into data in a format which is requested by a viewer and distribute the converted data, when the contents are distributed to the viewer via a communication network.

2. Description of the Related Art

Conventionally, in the case of distributing programs on a television broadcast and a radio broadcast, the options for viewable programs are limited to the number of channels. A viewer must select his desired program from the limited programs.

In recent years, a service for distributing the viewer's desired program, a so-called video on-demand (VOD) service is realized at a desired and convenient time, due to the widespread of communication network technologies such as the Internet and the improvement in information compressing techniques.

In a system for realizing the above service, in response to requests from a plurality of viewers, a content server which stores a plurality of contents such as a movie program and a music program distributes the contents to terminal devices of the viewers.

In the case of the video on-demand service, a viewer's desired content is requested to the content server from the terminal device installed in a viewer's house in accordance with a viewer's operation. Next, the request is transmitted to a distribution center which stores the content. After the request is received, the distribution center reads the content corresponding to the received request and distributes it to the terminal device. After the distribution content is received, the terminal device performs processing to play, fast-forward, rewind, or pause the content.

In the case of a pay-per-view service, an IRD (Integrated Receiver Decoder) is provided in the viewer's house. When the viewer requests a desired content, a key for viewing the pay-per-view content is reset in the IRD (that is, when video data is purchased), a video signal is outputted to a monitor. An IC card inserted in the IRD records the purchased data of the content. The IRD periodically reads the purchased data, which is recorded in the IC card, and transmits the read data to a customer management center as account information.

As mentioned above, in the case of the conventional content distributing service, the viewer can receive, from the content server, only content described in a format (data format) which can be read in the terminal device.

However, if there are a plurality of formats, conventionally, the content server must distribute the content in a format corresponding to the viewer's terminal device. Therefore, the content server needs to store the content described in the corresponding format.

Even if the content is in the single format, conventionally, the content server must distribute the viewer's desired content in accordance with a data rate corresponding to the viewer's request and a busy status of a communication path. Therefore, the content server needs to store the content converted into that of the corresponding data rate.

As mentioned above, the conventional content server must store the data corresponding to a plurality of formats and to a plurality of data rates for a single piece of content. Consequently, there is a problem in that not only a storage capacity is greatly increased but also it is difficult to manage the content, to change content, and to correspond to a new format.

As disclosed in Japanese Unexamined Patent Application Publication 10-303986, there is provided a method for distributing content to a terminal device by a content server via a broker application server.

In other words, when a transmitter distributes the content to a receiver, a computer as the transmitter transmits an address for specifying the receiver, in addition to the content data, to the broker application server. Based on the address received from the transmitter, the broker application server converts the data of the content into data in a format suitable for the receiver, and distributes the converted data of the content to the computer as the receiver. That is, the transmitter can convert the data of the content transparently.

However, according to the above method disclosed in Japanese Unexamined Patent Application 10-303986, when the transmitter having the data of the contents purchases a user right, there is a problem in that the structure of a system is complicated because the computer as the transmitter needs to accept a request of the content from the receiver and to transmit the content via the broker application server.

### SUMMARY OF THE INVENTION

Accordingly, to solve the problems, it is an object of the present invention to enable a content requested by a viewer to be easily converted into data of the content in a predetermined format and to be distributed.

According to a first aspect of the present invention, there is provided an information processing system for distributing a content to another device via a network, comprising: first receiving means for receiving application information of the content from the other device via the network; reading means for reading the content based on content identifying information included in the application information when the application information of the content is received by the first receiving means; format converting means for converting the content read by the reading means into data in a predetermined format based on format identifying information included in the application information; and distributing means for distributing the content which is converted into the data in the predetermined format by the format converting means, to the device via the network.

Also, there is provided the information processing system further comprising: second receiving means for receiving transaction information of the content; and authenticating means for authenticating the transaction information when the transaction information of the content is received by the second receiving means, wherein the reading means reads out the content based on a result authenticated by the authenticating means.

In addition, there is provided the information processing system wherein the transaction information includes a credit card number or an account number.

In addition, there is provided the information processing system wherein the format identifying information includes information which designates an encoding system and/or encoding rate of the content.

In addition, there is provided the information processing system further comprising: calculating means for calculating a use charge for the content based on the application information which is received by the first receiving means; and accounting means for accounting the use charge which is calculated by the calculating means, corresponding to the other device.

In addition, there is provided the information processing system further comprising: detecting means for detecting a busy status on the network, wherein the format converting means converts the content into data in a predetermined format based on the busy status which is detected by the detecting means.

According to a second aspect of the present invention, there is provided an information processing method for distributing a content to another device via a network comprising: a receiving step of receiving application information of the content from the other device via the network; a reading control step of controlling an operation for reading the content based on content identifying information included in the application information when the application information of the content is received in the receiving step; a format converting step of converting the content read in the reading control step into data in a predetermined format based on format identifying information included in the application information; and a distributing step of distributing the content which is converted into the data in the predetermined format in the format converting step, to the device via the network.

According to a third aspect of the present invention, there is provided a recording medium for recording a computer-readable program in an information processing system for distributing a content to another device via a network, wherein the program comprises: a receiving step of receiving application information of the content from the other device via the network; a reading control step of controlling an operation for reading the content based on content identifying information included in the application information when the application information of the content is received in the receiving step; a format converting step of converting the content read in the reading control step into data in a predetermined format based on format identifying information included in the application information; and a distributing step of distributing the content which is converted into the data in the predetermined format in the format converting step, to the device via the network.

According to the present invention, in the information processing system, the information processing method, and the recording medium for recording the program, when the application information of the content is received from a different device, the content is read based on the content identification information included in the application information, and the content is converted into the data in a predetermined format based on the format information included in the application information.

### BRIEF DESCRIPTION OF THE DRAWINGS

FIG. 1 is a block diagram showing an example of the structure of a content distributing system as an information processing system according to the present invention;

FIG. 2 is a block diagram showing an example of the structure of an information providing device in FIG. 1;

FIG. 3 is a block diagram showing an example of the structure of an information storing device in FIG. 1;

FIG. 4 is a block diagram showing an example of the structure of an information terminal device in FIG. 1;

FIG. 5 is a flowchart for explaining a content distributing process;

FIG. 6 is a flowchart for explaining the content distributing process corresponding to that of FIG. 5;

FIG. 7 is a flowchart for explaining a traffic check process; and

FIG. 8 is a block diagram showing an example of the structure of a hardware of the information providing device.

### DESCRIPTION OF THE PREFERRED EMBODIMENTS

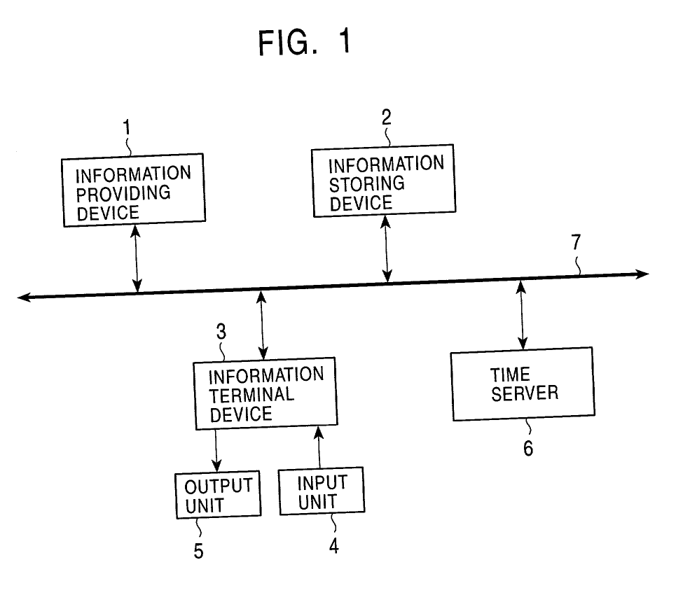

FIG. 1 shows an example of the structure of a content distributing system as an information processing system according to the present invention. The content distributing system as the information processing system comprises an information providing device 1, an information storing device 2, an information terminal device 3, and a time server 6, which are mutually connected via a communication network 7.

The information providing device 1 reads a desired content from the information storing device 2 in response to a request for distributing the content, which is transmitted from the information terminal device 3, converts the read content into data in a corresponding format and with a corresponding data rate, and distributes the converted data to the information terminal device 3 via the communication network 7. The information providing device 1 processes payment of a content distributing service, etc., for the information terminal device 3.

The information storing device 2 stores (has) data of a plurality of contents and licenses such as a copyright. Further, the information storing device 2 searches for a corresponding content based on a request from the information providing device 1, supplies the found content to the information providing device 1 via the communication network 7, and calculates a use charge for the content.

The information terminal device 3 requests the information providing device 1 to distribute a desired content via the communication network 7 based on an instruction, from a user, which is inputted by an input unit 4, and it designates the format and the data rate of the content. The information terminal device 3 receives the content distributed (provided) from the information providing device 1, and outputs and reads the content when necessary.

The input unit 4 comprises a keyboard, a mouse, a button, a remote controller, etc. An output unit 5 comprises an LCD (Liquid Crystal Display) or a CRT (Cathode Ray tube), and a speaker.

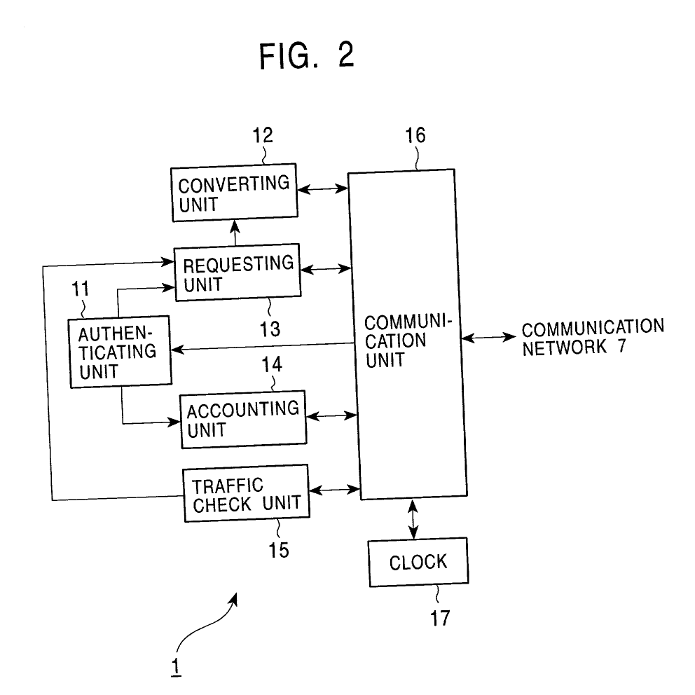

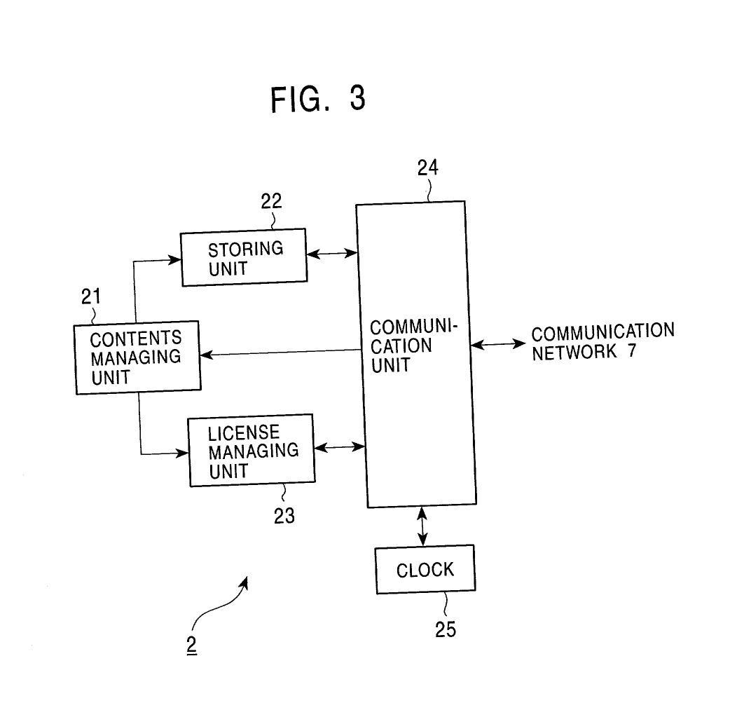

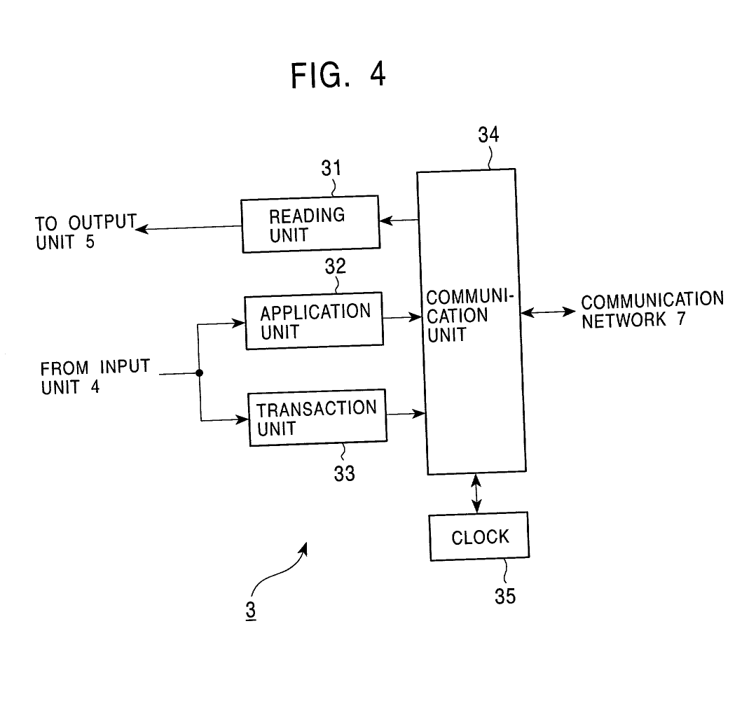

The time server 6 corrects times indicated by a clock (internal clock) 17 in FIG. 2 of the information providing device 1, a clock 25 in FIG. 3 of the information storing device 2, and a clock 35 in FIG. 4 of the information terminal device 3 so that the indicated times become a common time.

The communication network 7 performs wireless communication using a ground wave or a satellite broadcasting wave and, alternatively, wire communication using a telephone line, cable television, or the like.

FIG. 2 is a block diagram showing an example of the detailed structure of the information providing device 1.

An authenticating unit 11, as authenticating means, receives transaction information which is transmitted from the information terminal device 3 via the communication network 7 and a communication unit 6, such as a credit number and credit information on payment of a service charge for distributing the content, and decodes and checks encrypted credit information. Consequently, a buyer of the content is authenticated, and a result of the authentication is issued to a requesting unit 13 and an accounting unit 14 as calculating means and accounting means.

Incidentally, in the case of checking the credit information, when a user registration system is adopted, the authenticating unit 11 can check the credit information by using a user ID. When a credit card number informing system is adopted, the authenticating unit 11 inquires about the credit number to a credit company by using an encryption.

A converting unit 12, as format converting means, converts the data of the content, which is transmitted by the information storing device 2, based on a format ID included in application information received from the information terminal device 3, into data in a predetermined format and with a predetermined data rate. Further, the converting unit 12 distributes the converted data to the information terminal device 3 via a communication unit 16 as distributing means and the communication network 7. The format ID specifies a format such as MPEG (Moving Picture Experts Group), ATRAC (Adaptive Transform Acoustic Coding), or MP3 (MPEG Audio Layer 3).

However, when the data of the content, which is transmitted by the information storing device 2, has been already described in the format requested by the information terminal device 3, the converting unit 12 distributes the data of the content, which is transmitted by the information storing device 2, to the information terminal device 3. When the data of the content, transmitted by the information storing device 2, is subjected to specific encoding, the converting unit 12 temporarily decodes the data which is subjected to the specific encoding, thereafter, converts the data into data in the format requested by the information terminal device 3, and distributes the converted data to the information terminal device 3.

The requesting unit 13, as first and second receiving means, receives application information which is transmitted by the information terminal device 3 via the communication network 7 and the communication unit 16 as the distributing means, such as a content ID, a format ID, and information on application for distributing the content. Further, the requesting unit 13 transmits the content ID to the information storing device 2 via the communication unit 16 and the communication network 7 based on the received application information. As mentioned above, the data of the content corresponding to the content ID is requested by the information storing device 2.

Furthermore, the requesting unit 13 receives license information for the use of the data of the content, which is transmitted by the information storing device 2, via the communication network 7 and the communication unit 16. When the license information is encrypted, the requesting unit 13 decrypts the encrypted license information, thereby recognizing whether or not the data of the content is available.

The accounting unit 14, as the calculating means and the accounting means, requires the service charge for distributing the content purchased by a person (buyer) who has (uses) the information terminal device 3 and has a right for the content, and a transaction for paying the use charge for the content is executed online via the accounting unit 14. That is, the buyer of the content settles the service charge for distributing the content via the accounting unit 14, based on the credit information included in the transaction information which is received by the authenticating unit 11 from the information terminal device 3. The person having the right for the content settles the service charge for the content via the accounting unit 14.

The traffic check unit 15 digitizes communication traffic (a busy status of the communication path) on the communication network 7 and informs the digitized data of the requesting unit 13. As described above, the converting unit 12 can convert the data of the content into data with a data rate.

The communication unit 16 as the distributing means is connected to another device via the communication network 7, thereby transmitting data to the other device or receiving the data transmitted by the other device via the communication network 7.

The clock 17 stores time information received from the time server 6 via the communication network 7 and the communication unit 16.

FIG. 3 is a block diagram showing an example of the detailed structure of the information storing device 2.

The content ID for identifying the content and a corresponding relationship between the content ID and the data of the content are recorded on a content managing unit 21. The content managing unit 21, as reading means, receives the content ID requested to be distributed by the information terminal device 3, which is transmitted by the communication providing device 1 via the communication network 7 and the communication unit 16, and recognizes the license information and the content information including property information such as a recording address of a corresponding content, a size of the data of the content, and classification of audio data and video data.

In a storing unit 22, contents of various data such as audio data and a moving picture are recorded on a recording medium such as a semiconductor memory, a magnetic memory, or an optical disk. The storing unit 22 transmits data of the content, which is requested to be distributed, to the information providing device 1 via a communication unit 24 and the communication network 7 under the management of the content managing unit 21.

A license managing unit 23 records copyright properties including a title, a producer, a work No., and an account condition and distribution properties including license conditions indicating the number of copying times and a valid term, and sales conditions indicating a price, and a paying term, as the license information on the content. The license information on a specific content corresponds to data based on the content ID by the content managing unit 21. The license managing unit 23 encrypts the license information necessary for the distribution of the contents, transmits the encrypted information to the information providing device 1, and executes processing (transaction) for collecting the charge for the specific content from the information providing device 1.

The communication unit 24 is connected to another device via the communication network 7, thereby transmitting data to the other device and receiving the data transmitted by the other device via the communication network 7.

The clock 25 stores time information received from the time server 6 via the communication network 7 and the communication unit 24.

Incidentally, the content information used by the content managing unit 21 and the license information used by the license managing unit 23 can be stored in a part of a storage area of the storing unit 22.

FIG. 4 is a block diagram showing an example of the detailed structure of the information terminal device 3.

A reading unit 31 receives the data of the content, transmitted by the information providing device 1, via the communication network 7 and a communication unit 34. If the format is subjected to predetermined encoding, the received encoded data is subjected to predetermined decoding by the reading unit 31. The reading unit 31 outputs the read data after the decoding to the output unit 5. For example, when the read data is image data, it is displayed on the LCD (not shown). When the read data is audio data, it is outputted to the speaker (not shown).

An application unit 32 transmits the application information on the content ID for identifying the content and on the format ID for identifying the format and the data rate of the encoding, which is requested by the buyer of the content, to the information providing device 1 via the communication unit 34 and the communication network 7. Thereby, the application unit 32 requests the distribution of the content.

When the input unit 4 is operated by the buyer of the content, a viewing charge for the content, a credit card number necessary for paying the service charge for the distribution of the content, and the transaction information on an account number of a deposit (referred to as an account No.) are inputted. A transaction unit 33 encrypts the transaction information, transmits the encrypted transaction information to the information providing device 1 via the communication unit 34 and the communication network 7, and executes a transaction for paying the billed amount.

The communication unit 34 is connected to another device via the communication network 7, thereby transmitting data to the other device or receiving the data transmitted by the other device via the communication network 7.

The clock 35 stores the time information received from the time server 6 via the communication network 7 and the communication unit 34.

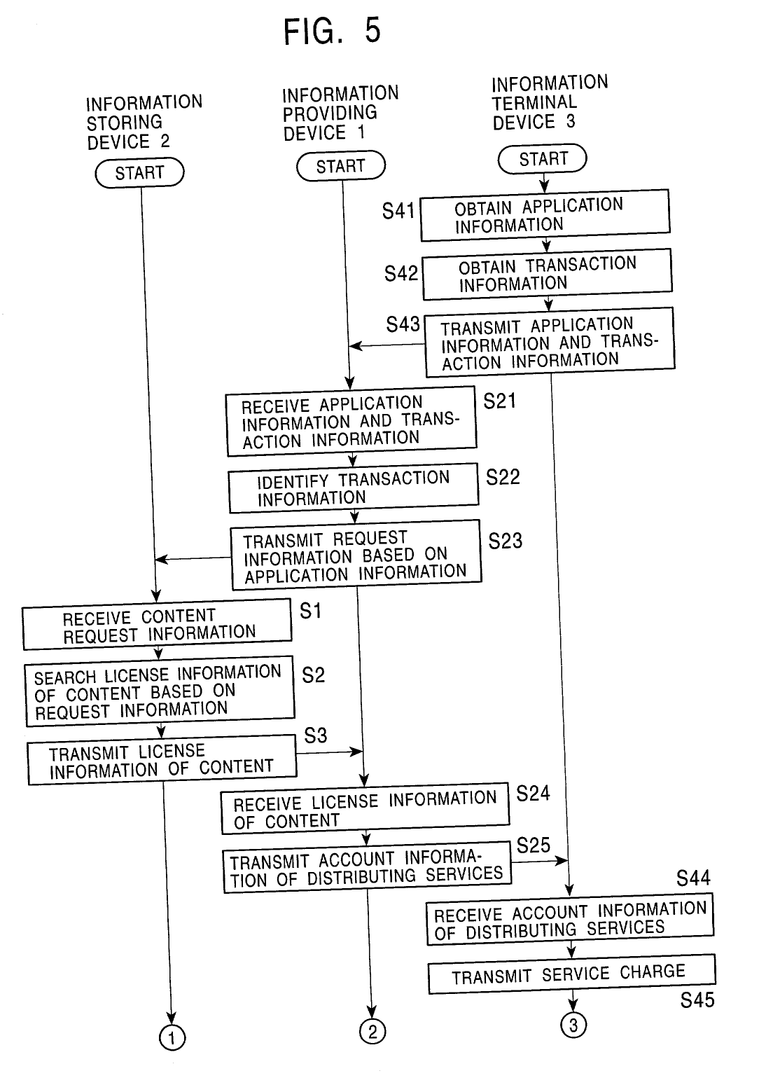

Hereinbelow, a description is given of the content distributing processing which is executed by the information providing device 1 with reference to FIG. 5.

In step S41, the application unit 32 in the information terminal device 3 allows the output unit 5 to display an input screen on the LCD, and instructs a buyer of a desired content to input the application information such as the content and the format thereof, thereby obtaining the application information. In step S42, the transaction unit 33 in the information terminal device 3 allows the output unit 5 to display an input screen on the LCD, and instructs the buyer of the content to input the transaction information such as the credit card number and the account No., thereby obtaining the transaction information.

In step S43, the communication unit 34 in the information terminal device 3 encrypts the application information and the transaction information obtained in steps S41 and S42 as necessary, and transmits the encrypted information to the information providing device 1 via the communication network 7.

In step S21, the communication unit 16 in the information providing device 1 receives the application information and the transaction information which are transmitted by the information terminal device 3. In step S22, the authenticating unit 11 in the information providing device 1 decrypts the transaction information received in step S21 as necessary, and checks whether or not the transaction information is legal by inquiring about the decrypted transaction information of a credit company, a bank, or the like online.

Hereinbelow, a description is given of the authenticating process of the transaction information. If a user identification (hereinafter, referred to as a user ID) and a password are used, the authenticating unit 11 checks whether or not the user ID and the password inputted by the buyer of the content have been already registered to an authentication list which the information providing device 1 has, in accordance with a protocol for authentication using the encryption. If it is determined that the user ID and the password have been already registered, the information providing device 1 distributes the content to the information terminal device 3. If it is determined that the user ID and the password have not been registered, the information providing device 1 issues, for example, a message of “Not authenticated” indicating the information terminal device 3. Although the authenticating unit 11 in the information providing device 1 performs the authenticating process, another authenticating unit (not shown) connected to the communication network 7 may be authenticated.

Referring back to FIG. 5, if it is determined in step S22 that the user ID and the password have been already registered, the processing routine advances to step S23 whereupon the requesting unit 13 in the information providing device 1 decodes the application information received in step S21 as needed, and recognizes the content of the buyer. Then, the requesting unit 13 transmits the information which requests the use of the content, including the content ID for identifying content, to the information storing device 2 via the communication unit 16 and the communication network 7.

In step S1, the content managing unit 21 in the information storing device 2 receives the request information which is transmitted by the information providing device 1 via the communication network 7 and the communication unit 24. In step S2, the license managing unit 23 in the information storing device 2 searches for the license information on the content corresponding to the content ID included in the request information which is received in step S1 by using the content ID.

In step S3, the communication unit 24 in the information storing device 2 transmits the license information satisfying the content described in the request information via the communication network 7. If the license information satisfying the content described in the request information cannot be found, the license managing unit 23 issues, for example, a message indicating “The request content is not acceptable” of the information terminal device 3 via the information providing device 1.

In step S24, the communication unit 16 in the information providing device 1 receives the license information of the content which is transmitted by the information storing device 2. In step S25, the accounting unit 14 in the information providing device 1 calculates the charge for the content to be paid by the buyer of the content based on the license information on the content, which is received in step S24, and forms account information which requires the service charge for distributing the content, including the use charge for the content. The accounting unit 14 transmits the account information for the distribution service formed, to the information terminal device 3 via the communication unit 16 and the communication network 7.

In step S44, the communication unit 34 in the information terminal device 3 receives the account information on the distribution of the service, which is transmitted by the information providing device 1, via the communication network 7. In step S45, the transaction unit 33 in the information terminal device 3 transmits the service charge which is required based on the account information on the distribution of the service, which is received in step S44, to the information providing device 1 via the communication network 7 and the communication unit 34.

In step S26, the communication unit 16 in the information providing device 1 receives the service charge which is transmitted online via the communication network 7. In step S27, the accounting unit 14 in the information providing device 1 recognizes the service charge from the information terminal device 3, which is received in step S26. The accounting unit 14 recognizes that the payment of the service charge by the buyer is completed and, thereafter, transmits the use charge for the content to the information storing device 2 online to the person having the right for the content.

Although the information providing device 1 performs the accounting operation for the buyer of the content, as an accounting method of the content, an Internet provider to which the buyer of the content subscribes can charge not only the service charge for the content but also a network access charge to the buyer. Thus, the buyer can pay the service charge by using a credit card which has been already registered to the Internet provider or a prepaid card which is purchased at a book store or a convenience store.

In step S4, the communication unit 24 in the information storing device 2 receives the use charge for the content, which is transmitted online by the information providing device 1, via the communication network 7. In step S5, the content managing unit 21 in the information storing device 2 recognizes the use charge for the content, transmitted online by the information providing device 1, which is received in step S4. The content managing unit 21 checks that the payment of the use charge for the content is completed. After that, the content managing unit 21 searches for the requested content based on the request information which is received in step S1, and reads the data of the content from the storing unit 22.

In step S6, the communication unit 24 in the information storing device 2 transmits the data of the content, which is read in step S5, to the information providing device 1 via the communication network 7.

In step S28, the communication unit 16 in the information providing device 1 receives the data of the content, which is transmitted by the information storing device 2, via the communication network 7. In step S29, the converting unit 12 in the information providing device 1 converts the data of the content, which is received in step S28, into data in a proper format and with a proper data rate based on the format ID included in the application information, which is received in step S21, and traffic information obtained as a result of a traffic check process, which will be described later.

If the format designated by the application information needs specific encoding, the data of the content is subjected to the predetermined encoding. Specific modes in the specific encoding, e.g., an encoding rate and the number of channels, can be designated as the application information. In this case, the converting unit 12 can execute the encoding in a designated mode. If the encoding rate is determined in consideration of the traffic of the communication network 7, the encoding rate can be limited by using the traffic information.

In step S30, the communication unit 16 in the information providing device 1 transmits the data of the content, which is converted in step S29, to the information terminal device 3 via the communication network 7.

In step S46, the communication unit 34 in the communication terminal device 3 receives the data of the content, which is transmitted after the conversion, via the communication network 7. In step S47, the reading unit 31 in the information terminal device 3 outputs the data of the content after the conversion, which is received in step S46, to the output unit 5 and reads it. Incidentally, when the read data is image data (not shown), it is displayed on the LCD and, when the read data is audio data (not shown), it is outputted to the speaker.

If the format designated by the application information needs specific encoding, that is, when the buyer of the content designates the specific encoding and applies the distribution of the content, the reading unit 31 executes the decoding corresponding to the designated encoding, thereby reading the content.

As described above, the information providing device 1 converts the data of the content into the data in format requested by the information terminal device 3. Therefore, with respect to the same content, it is unnecessary to store the contents in a plurality of formats. The content can be easily distributed.

Although the process for accounting the service charge in the distribution of the content and the use charge for the content is executed before distributing the content, the present invention is not limited to this. After distributing the content, the accounting process can be executed. The process for accounting the service charge and the use charge for the content is implemented every transaction of the content. However, the process for accounting the charge stored for a predetermined time can be periodically performed and, alternatively, the charge for a predetermined term can be fixed.

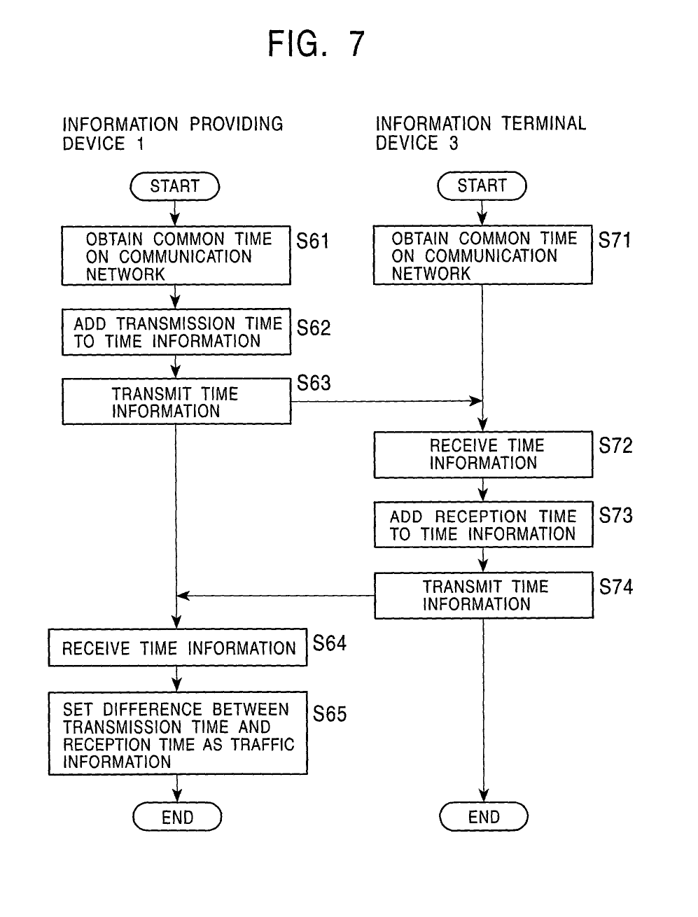

FIG. 7 is a flowchart for explaining the traffic check process on the communication network 7, which is executed by the information providing device 1.

In step S61, the clock 17 in the information providing device 1 obtains the common time on the communication network 7 from the time server 6 via the communication network 7 and the communication unit 16, and stores it. The traffic check unit 15 forms the time information including information capable of identifying the traffic check unit 15 itself. In step S71, the clock 35 in the information terminal device 3 obtains the common time on the communication network 7 from the time server 6 via the communication network 7 and the communication unit 34, and stores it.

In step S62, the traffic check unit 15 in the information providing device 1 reads the present time from the clock 17, sets the read time as a transmission time, and adds the transmission time to the time information formed in step S61. In step S63, the communication unit 16 in the information providing device 1 transmits, via the communication network 7, the time information with the transmission time added in step S62 to the information terminal device 3 which requests the distribution of the content.

In step S72, the communication unit 34 in the information terminal device 3 receives the time information which is transmitted by the information providing device 1, via the communication network 7. In step S73, the clock 35 in the information terminal device 3 sets the present time as the reception time, and adds the reception time to the time information which is received in step S71. In step S74, the communication unit 34 in the information terminal device 3 transmits the time information with the reception time, which is added in step S73, to the information providing device 1 via the communication network 7.

In step S64, the communication unit 16 in the information providing device 1 receives the time information, which is transmitted by the information terminal device 3, via the communication network 7. In step S65, the traffic check unit 15 in the information providing device 1 calculates a difference between the reception time and the transmission time which are added to the time information received in step S64, and recognizes the traffic information on the communication network 1.

The traffic check unit 15 repeatedly executes the above-mentioned processing a plurality of times, thereby obtaining the traffic information with higher reliability. The information providing device 1 presets the data rate for the encoding, which is recommended for different communication traffic. Thereby, the converting unit 12 can limit or change the data rate for the encoding of the converted content based on the traffic information which is obtained in the above processing.

As described above, by obtaining the traffic information on the communication network 7, the data of the content can be distributed with a further proper data rate for the encoding.

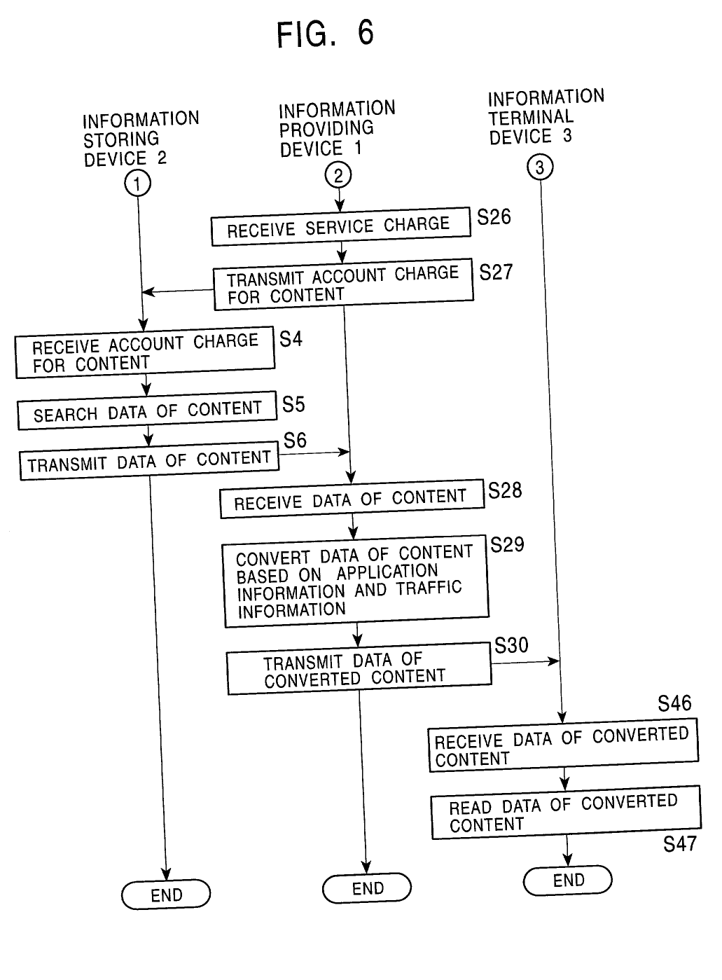

The above traffic check process can be performed simultaneously with the content distributing processing which is described in the flowcharts of FIGS. 5 and 6.

The format inputted by the buyer of the content is transmitted (issued) to the information providing device 1 in the above description. However, if an owner of the information terminal device 3 does not know the format corresponding thereto, by previously storing the corresponding format in a memory integrated in the information terminal device 3, the corresponding format can be read and transmitted to the information providing device 1 together with the content ID when the content ID is transmitted.

As mentioned above, since the information providing device 1 converts the content into the data of the content in the corresponding format based on the format ID requested by the information terminal device 3 when the content is distributed, the content suitable to the information terminal device 3 can be distributed. Therefore, according to the present invention, the following advantages can be obtained.

(1) The information providing device 1 converts the content into the data of the content in the format which is requested by the buyer thereof, distributes them, and mediates the accounting operation of the content between the buyer of content and the person having the right for the content.

(2) The person having the right for the content does not need to store the contents in a plurality of formats and the contents with a plurality of data rates. Thus, the content can be stored in the format suitable to the person having the right for the content.

(3) The buyer of the content can use the content in the desired format corresponding to the information terminal device 3.

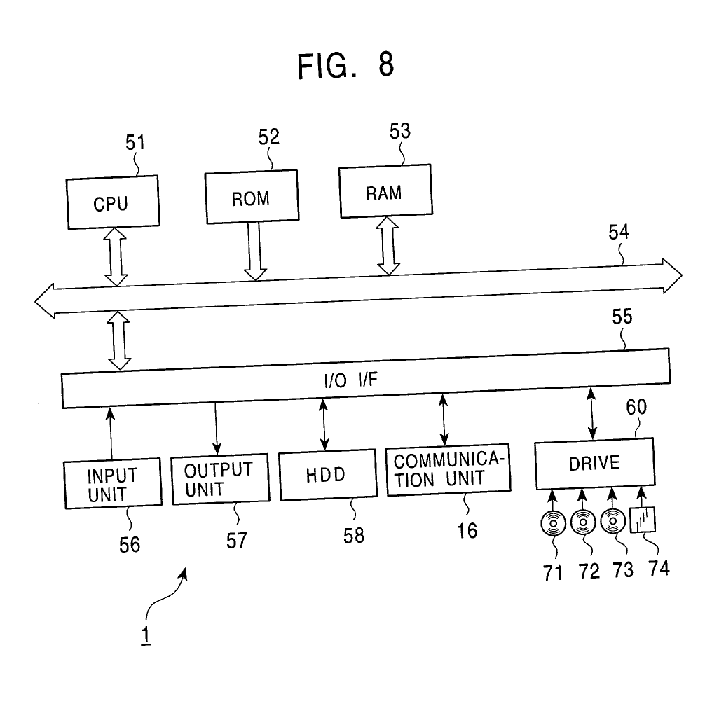

The information providing device 1 is structured, for example, as shown in FIG. 8. Although not shown, the information storing device 2 and the information terminal device 3 are similarly structured. In the information providing device 1, a CPU (Central Processing Unit) 51 executes various processing in accordance with programs stored in a ROM (Read-Only Memory) 52 and a hard disk drive 58. When the CPU 51 executes the various processing, necessary program and data are properly stored in a RAM (Random Access Memory) 53. The CPU 51, the ROM 52, and the RAM 53 are mutually connected via a bus 54 and are connected to an input/output interface 55.

Connected to the input/output interface 55 of the information providing device 1, the information storing device 2, or the information terminal device 3, are an input unit 56 comprising a keyboard and a mouse, an output unit 57 comprising an LCD or a CRT, and a speaker, the hard disk drive 58, and the communication unit 16 for communicating with the communication network 7. A drive 60 for installing the programs as needed is connected to the input/output interface 55. Loaded in the drive 60 is a magnetic disk 71, an optical disk 72, an magneto-optical disk 73, a semiconductor memory 74, or the like.

Although a series of the above processing can be executed by hardware, it can also be executed by software. In this case, programs for the configuration of software are installed in a computer, etc. from a recording medium. The computer may be integrated in dedicated hardware. Alternatively, the computer may be a computer for general use, which can execute various functions by installing various programs or the like.

As shown in FIG. 8, besides the computer, the recording medium also comprises a package medium which is distributed to provide a program to a user, having the magnetic disk 71 (in this case, including a floppy disk), the optical disk 72 (in this case, including a CD-ROM (Compact-Disk Read-Only Memory) and a DVD (Digital Versatile Disk)), the magneto-optical disk 73 (in this case, including an MD (Mini Disk)), the semiconductor memory 74, or the like. Further, the recording medium comprises the ROM 52 in which the programs are recorded, the hard disk drive 58, and the like, which are provided to the user in such a state that they are integrated in the computer in advance.

According to the present invention, steps of describing the programs recorded on the recording medium include not only processes which are time-serially performed in the described order but also processes which are performed in parallel or individually though not necessarily time-sequentially performed.

According to the present invention, the system corresponds to the overall device comprising a plurality of devices.

What is claimed is:

1. An information processing system for distributing a content to another device via a network, comprising:
first receiving means for receiving application information of said content from said other device via said network;
reading means for reading said content based on content identifying information included in said application information when said application information of said content is received by said first receiving means;
format converting means for converting said content read by said reading means into data in a predetermined format based on format identifying information included in said application information; and
distributing means for distributing said content which is converted into the data in the predetermined format by said format converting means, to said device via said network.

2. A system according to claim 1, further comprising:
second receiving means for receiving transaction information of said content; and
authenticating means for authenticating said transaction information when the transaction information of said content is received by said second receiving means,
wherein said reading means reads out said content based on a result authenticated by said authenticating means.

3. A system according to claim 2, wherein said transaction information includes a credit card number or an account number.

4. A system according to claim 1, wherein said format identifying information includes information which designates an encoding system and/or encoding rate of said content.

5. A system according to claim 1, further comprising:
calculating means for calculating a use charge for said content based on said application information which is received by said first receiving means; and
accounting means for accounting said use charge which is calculated by said calculating means, corresponding to said other device.

6. A system according to claim 1, further comprising:
detecting means for detecting a busy status on said network,
wherein said format converting means converts said content into data in a predetermined format based on said busy status which is detected by said detecting means.

7. An information processing method for distributing a content to another device via a network comprising:
a receiving step of receiving application information of said content from said other device via said network;
a reading control step of controlling an operation for reading said content based on content identifying information included in said application information when the application information of said content is received in said receiving step;
a format converting step of converting said content read in said reading control step into data in a predetermined format based on format identifying information included in said application information; and
a distributing step of distributing said content which is converted into the data in the predetermined format in said format converting step, to said device via said network.

8. A recording medium for recording a computer-readable program in an information processing system for distributing a content to another device via a network,
wherein said program comprises:
a receiving step of receiving application information of said content from said other device via said network;
a reading control step of controlling an operation for reading said content based on content identifying information included in said application information when the application information of said content is received in said receiving step;
a format converting step of converting said content read in said reading control step into data in a predetermined format based on format identifying information included in said application information; and
a distributing step of distributing said content which is converted into the data in the predetermined format in said format converting step, to said device via said network.
